(19) United States
(12) Patent Application Publication
(10) Pub. No.: US 2004/0251997 A1
(43) Pub. Date: Dec. 16, 2004

(54) Economical ferrite-type magnets with enhanced properties

(76) Inventors: Antoine Morel, Le Boulay Morin (FR); Philippe Tenaud, Bernin (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/491,895

(22) PCT Filed: Oct. 14, 2002
(86) PCT No.: PCT/FR02/03516

(30) Foreign Application Priority Data
Oct. 19, 2001 (FR) 01/13542

(51) Int. Cl. H01F 7/02

(52) U.S. Cl. 335/302

(57) ABSTRACT

The invention concerns a ferrite magnet comprising a magnetoplumbite phase of formula M₁₋ₐRₐFe_{12-y}T_{y}O₁₉, wherein: M represents at least an element selected among the group consisting of: Sr, Ba, Ca and Pb; R represents at least an element selected among rare earths and Bi; T represents at least an element selected among Co, Mn, Ni, Zn; 0.15<x<0.42; 0.50<α=y/x<0.90, so as to provide a ferrite magnet having both a reduced level in element T and a global performance index GIP=Br+0.5.Hk not less than 580, and preferably not less than 585, Br being the remanent induction expressed in mT, Hk corresponding to the field H expressed in kA/m, for B=0.9.Br.

### BACKGROUND OF THE INVENTION

The invention pertains to the area of magnets of hexagonal ferrite type containing the M magnetoplumbite phase.

### PRIOR ART

Magnets of ferrite type are already known containing the magnetoplumbite phase and having the formula M Fe₁₂O₁₉ where M=Sr, Ba, Ca, Pb, etc.

Magnets of this type are also known having the formula (M₁₋ₓRₓ)O●n[Fe_{12-y}T_{y}))₂O₃].

European application EP 0 964 411 A1 for example describes magnets in which:

M is an element chosen from Sr and/or Ba,

R is an element belonging to the rare earths,

T is an element chosen from among Co, Mn, Ni and Zn, where:

x ranges from 0.01 to 0.4,

y ranges from [x/(2.6n)] to [x/(1.6n]

and n ranges from 5 to 6.

Also, European application EP 0 905 718 A1 describes magnets of this type having the formula M₁₋ₓRₓ(Fe_{12-y}T_{y})_{z}O₁₉ in which:

M is an element chosen from among Sr, Ba, Ca and Pb, and essentially Sr,

R is an element belonging to the rare earths or Bi, and essentially La,

T is Co or Co and Zn, where:

x ranges from 0.04 to 0.9,

y ranges from 0.04 to 0.5, with x/y ranging from 0.8 to 20, and

z ranges from 0.7 to 1.2.

This type of magnet is also described in European patent applications EP 0 758 786 A1, EP 0 884 740 and EP 0 940 823 A1, U.S. Pat. No. 6,258,290 and EP 1 150 310 A1.

The manufacture of such magnets typically comprises the following steps:

a) forming a mixture of the raw materials either using a wet process to form a dispersion, or by a dry process to form granules,

b) calcining the mixture at around 1250° C. to form a clinker containing the desired magnetoplumbite phase, said mixture, either in the form of a dispersion or in granule form, being placed in a calcining oven,

c) wet grinding of the clinker until an aqueous dispersion of particles is obtained with a particle size in the region of 1 μm, in the form a paste containing approximately 70% dry extract,

d) the paste is concentrated and compressed under an orienting magnetic field of approximately 1 Tesla and under a pressure of 30 to 50 MPa to obtain a green compact that is anisotropic and typically contains 87% dry extract,

e) after drying and removing the remaining water, sintering the green compact,

f) final machining to obtain a magnet of predetermined shape.

Manufacturing processes are also known such as those described in French applications N° 99 10295 and 99 15093 on behalf of the applicant.

Problems Raised

The problems raised by magnets of ferrite type in the state of the art, typically magnets of the type Sr₁₋ₓLaₓFe_{12-y}CO_{y}O₁₉, are twofold:

firstly the iron substitution element, typically cobalt, is a costly product,

secondly even though known magnets have high magnetic properties, typically measured using an index of performance IP=Br+0.5HcJ where Br denotes remanent induction (mT) and HcJ the coercive field (kA/m), a certain number of magnet applications require magnets having a magnetizing curve Br=f(H) that is as square as possible, this squareness typically being given by the ratio h_{K}=Hk/HcJ, Hk being the reverse field giving an induction of 0.90.Br. Hk in fact corresponds to the field from which magnetic losses are considered to be irreversible.

The invention sets out simultaneously to obtain magnets of ferrite type which, in addition to generally high magnetic properties, are low cost and whose squareness given by the ratio h_{K}=Hk/HcJ is greater than that obtained under identical operating conditions, and is typically at least 0.95.

Having regard to the predominant importance of the Hk factor, a Global Index of Performance GIP=Br+0.5.Hk is proposed to take into consideration both the end magnetic properties and the squareness of the magnetising and demagnetising curves. The invention sets out to obtain magnets having a global index of performance GIP of at least 580, preferably of at least 585 and even of at least 590.

### DESCRIPTION OF THE INVENTION

According to the invention, the magnet of ferrite type has magnetoplumbite phase structure (hexaferrite of M structure) with the formula M₁₋ₓRₓFe_{12-y}T_{y}O₁₉ in which:

M designates at least one element chosen from the group made up of: Sr, Ba, Ca and Pb,

R designates at least one element chosen from among the rare earths and Bi,

T designates at least one element chosen from among Co, Mn, Ni, Zn,

0.15<x<0.42

0.50<α=y/x<0.90

so as to obtain a ferrite magnet simultaneously having a low percentage of element T and a global index of performance GIP=Br+0.5Hk of at least 580, and preferably of at least 585, Br being the remanent induction expressed in mT, Hk corresponding to the field H expressed in kA/m, where B=0.9 Br, Br being the remanent induction.

Further to its research in the area of permanent magnets, and more particularly magnets of ferrite type having magnetoplumbite or hexaferrite structure, permanent magnets of basic structure MFe₁₂O₁₉ where M=Sr, Ba, Pb, Ca substituted by other elements and having as chemical formula M₁₋ₓRₓFe_{12-y}T_{y}O₁₉ where R denotes the element Bi or a rare earth, and T designates an element Mn, Co, Ni, Zn, the applicant continued its investigations with a view firstly to improving the magnetic performance represented by an index of performance IP=Br+0.5.HcJ, Br designating remanent induction expressed in mT and HcJ being the coercive field expressed in kA/m, and secondly with a view to improving a second important parameter for permanent magnets, namely the squareness of the demagnetising curve generally characterized by h_{K}=Hk/HcJ (%) Hk corresponding to field H when B=0.9 Br, and to obtain h_{K} at least equal to 0.95.

Indeed it was observed by the applicant that with numerous types of substitution, for example where R =La and T=Co, the squareness h_{K} deteriorates sharply, which can strongly limit the applications of these magnets.

The research conducted therefore set out to greatly increase squareness h_{K}, without deteriorating the global magnetic performance IP of the magnets, so as to obtain a global index of performance GIP at least equal to 580 and preferably to at least 585 and even of at least 590.

Conventionally, to produce the mixture of raw materials, the variable “x” of the ferrite magnet formula is taken to be equal to the variable “y” so as to observe the electroneutrality of the magnet whose formula, where R═La and T=Co, is assumed to be:

Sr₁₋ₓ²⁺Laₓ³⁺Fe₁₂₋ₓ³⁺COₓ²⁺O₁₉

Having examined the squareness of these ferrite magnets obtained, in relation to the rate of substitution x=y, the applicant observed, as illustrated in FIG. 1a, a deterioration in this squareness as and when x=y increased—at least as far as x=y=0.3.

The applicant also observed, as illustrated in FIG. 1b, that there is a variation in the field of anisotropy Ha (kA/m) and the coercive field HcJ (kA/m) in relation to the rate of substitution x=y. It therefore arises that if the intrinsic magnetic properties given by the anisotropy field Ha, increase with x=y, on the other hand the macroscopic magnetic properties of the ferrite, given in particular by the coercive field HcJ, show an optimum at around x=y=0.2.

In addition, after X-ray diffraction analysis of the magnets obtained above in which x=y, the applicant noticed the particular presence of a spinel Co phase (CoFe₂O₄) while lanthanum appears to substitute completely for strontium.

The applicant made a first assumption that part of the Co element probably does not take part in the formation of the ferrite per se, and that this could lead to the transformation of initial Fe³⁺ into Fe²⁺ in the ferrite.

To verify this hypothesis, it examined the resistivity of ferrite magnets obtained when x=y ranges from 0 to 0.4. The applicant observed a rapid drop in resistivity (see FIG. 2). It also made the assumption that this reduced resistivity could relate to the increasing presence of the ion couple Fe²⁺—Fe³⁺ taking into account the possible conduction through electron hopping between the Fe²⁺ and Fe³⁺ ions.

The applicant also put forward the hypothesis that the presence of said Co spinel phase could be the cause of the deterioration in the squareness h_{K} of the ferrite magnets tested.

It is this work on the preceding hypotheses which has led the applicant, in order to solve the problems raised, to exploring the area of ferrites that:

are weakly substituted,

in which x differs from y.

The applicant found that the polygonal domains shown in FIGS. 3, 4a and 4b, in a fully unexpected manner, made it possible to solve the problems raised.

As illustrated in FIG. 5e, with the invention it is possible, all other things being equal, both to reduce the content of the T element in ferrite magnets—an element which is generally costly—and to increase the overall performance of the ferrite magnet.

### DESCRIPTION OF THE FIGURES

FIG. 1a is a graph showing the variation in the squareness h_{K} (%) on the ordinate in relation to x and y on the abscissa, for a ferrite having the formula Sr₁₋ₓLaₓFe_{12-y}CO_{y}O₁₉ in which x=y.

FIG. 1b is a graph illustrating the variation in the coercive field HcJ (kA/m) on the left ordinate—the curve points being squares, and the anisotropic field Ha (kA/m) on the right ordinate—the curve points being triangles—in relation to x and y on the abscissa for a ferrite of formula Sr₁₋ₓLaₓFe_{12-y}CO_{y}O₁₉ in which x=y.

FIG. 2 is a graph illustrating the variation in resistivity, on the ordinate (log ρ in Ωcm) in relation to x and y, on the abscissa, for a ferrite having the formula Sr₁₋ₓLaₓFe_{12-y}CO_{y}O₁₉ in which x=y.

FIG. 3 is a graph carrying the x coefficients on the abscissa and y coefficients on the ordinate (coefficients of the ferrite formula M₁₋ₓRₓFe_{12-y}T_{y}O₁₉) illustrating different domains of the invention, the chief domain being the straight lines:

x₁=0.15 and x₂=0.42

α₁=0.50 and α₂=0.90

Other sub-domains are delimited by other straight lines:

x=0.1−0.22−0.32

α=0.60−0.65−0.75−0.80

FIG. 3 lists the different tests conducted, the different series of tests being marked: A for x=0, B for x=0.15, C for x=0.20, D for x=0.30 and E for x=0.40.

FIGS. 4a and 4b are similar to FIG. 3 and correspond to restricted domains:

the polygonal domain (hatched) in FIG. 4a is delimited by the straight lines:

x₁=0.17 and x₂=0.32

α₁>0.65 and α₂<0.90

the polygonal domain (hatched) in FIG. 4b, inscribed within the preceding one, is limited by the straight lines:

x₁=0.17 and x₂=0.22

α₁>0.65 and α₂<0.90

An even more restricted domain (counter hatched) is limited by the straight lines:

x₁=0.17 and x₂=0.22

α₁>0.65 and α′₂<0.80

FIGS. 5a to 5e show the results obtained (on the ordinate) in relation to the parameter α=y/x for tests B1-1, C1-1, C3-1, C4-1, C5-1 and D1-1 which correspond to magnets sintered at a temperature of 1180° C.

FIG. 5a shows the remanent induction Br in mT on the ordinate axis.

FIG. 5b, on the ordinate, shows Hk corresponding to the field H expressed in kA/m where B=0.9.Br, Br being remanent induction.

FIG. 5c, on the ordinate, shows the coercive field HcJ in kA/M.

FIG. 5d, on the ordinate, shows the index of performance IP=IP=Br+0.5HcJ.

FIG. 5e, on the ordinate, shows the Global Index of Performance GIP=Br+0.5.Hk

FIG. 6 gives examples of demagnetising curves, as a dotted line for test C1-1, and as a solid line for C3-1.

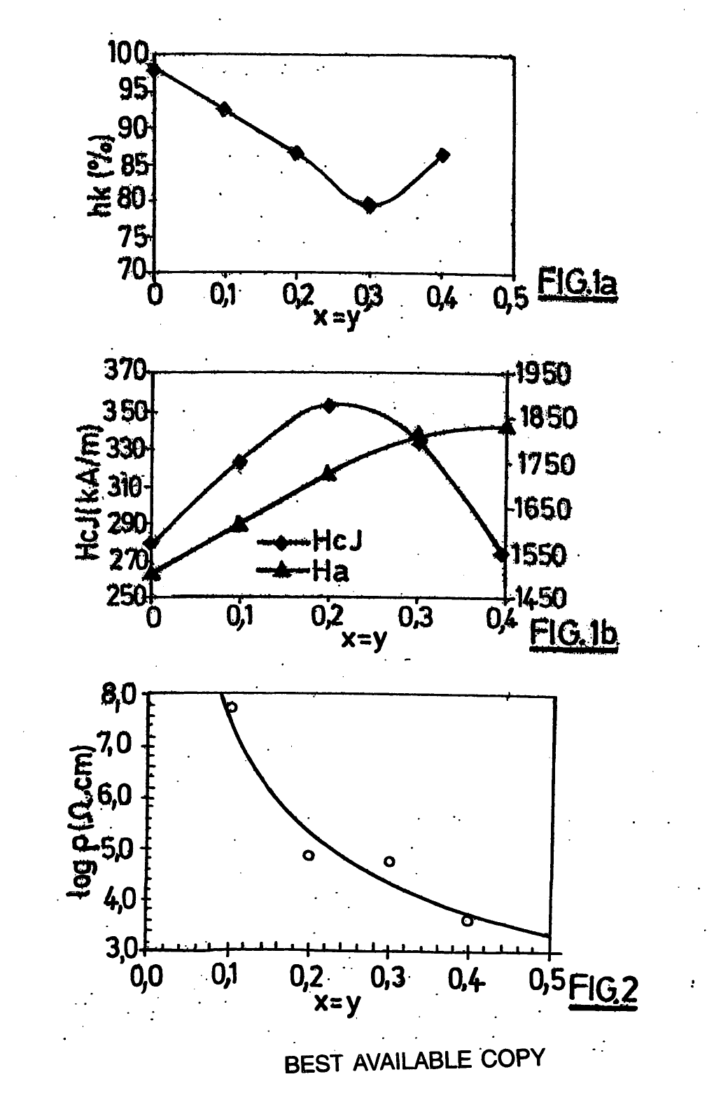

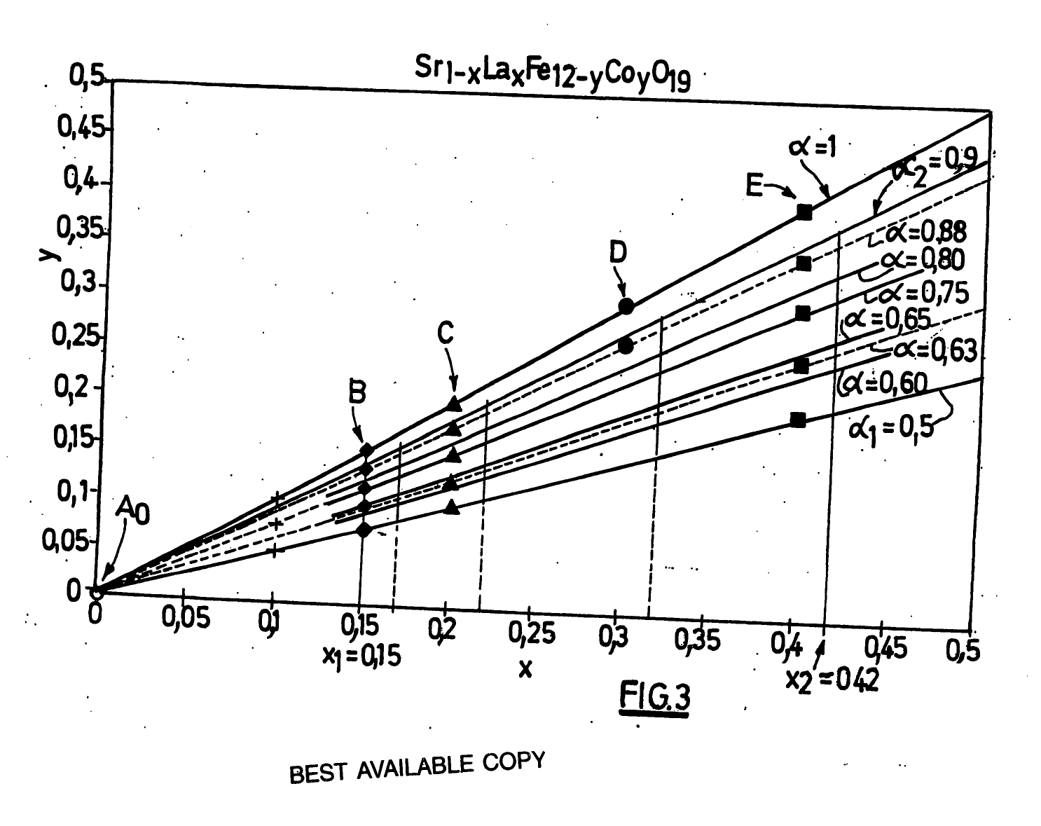

### DETAILED DESCRIPTION OF THE INVENTION

The areas of the invention, in particular those defined by the ranges of coefficients x and α, were determined subsequent to numerous studies and tests performed by the applicant of which a certain number are given in the exemplary embodiments.

As a general rule, coefficient a is taken to be no more than 0.90 so as simultaneously to obtain a significant reduction in element T content and an increase in the global performance GIP, as was observed in surprising manner.

On the other hand, the applicant observed a lower limit for α=0.5 on account of the deterioration in global performance GIP.

Similarly, concerning coefficient x, this may vary according to the invention over a range of 0.15 to 0.42. It was observed by the applicant that it is not advantageous to go beyond x=0.2 in particular on account of the very high content of element T. Since, even if good overall performance can be obtained with a high x, this is not necessarily advantageous insofar as identical or better performance can be obtained with lower x values, and consequently with a lower content of element T in the ferrite. As explained below, it is preferred not to exceed a value of x=0.32.

On the other hand, there is a lower limit to the possible reducing of coefficients x (and hence y) and the applicant observed too great a reduction in magnetic properties—a reduction which does not offset the improved squareness or cost reduction, as soon as x is typically less than 0.15.

According to the invention, magnets with the formula M₁₋ₓRₓFe_{12-y}T_{y}O₁₉ advantageously meet the following condition: 0.15<x<0.32.

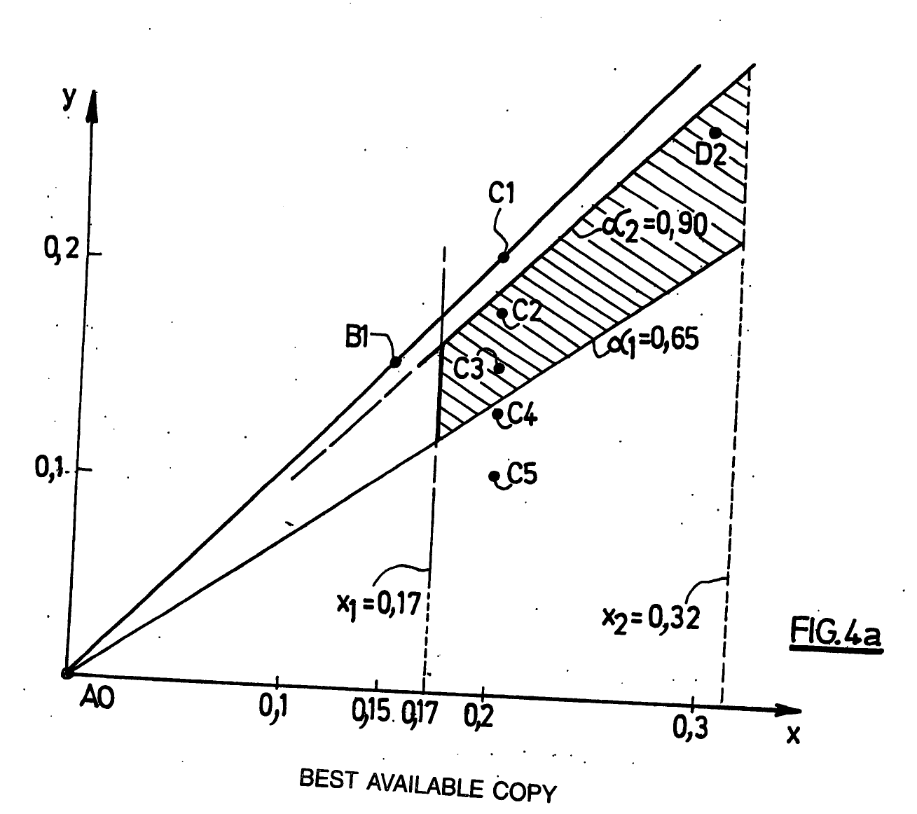

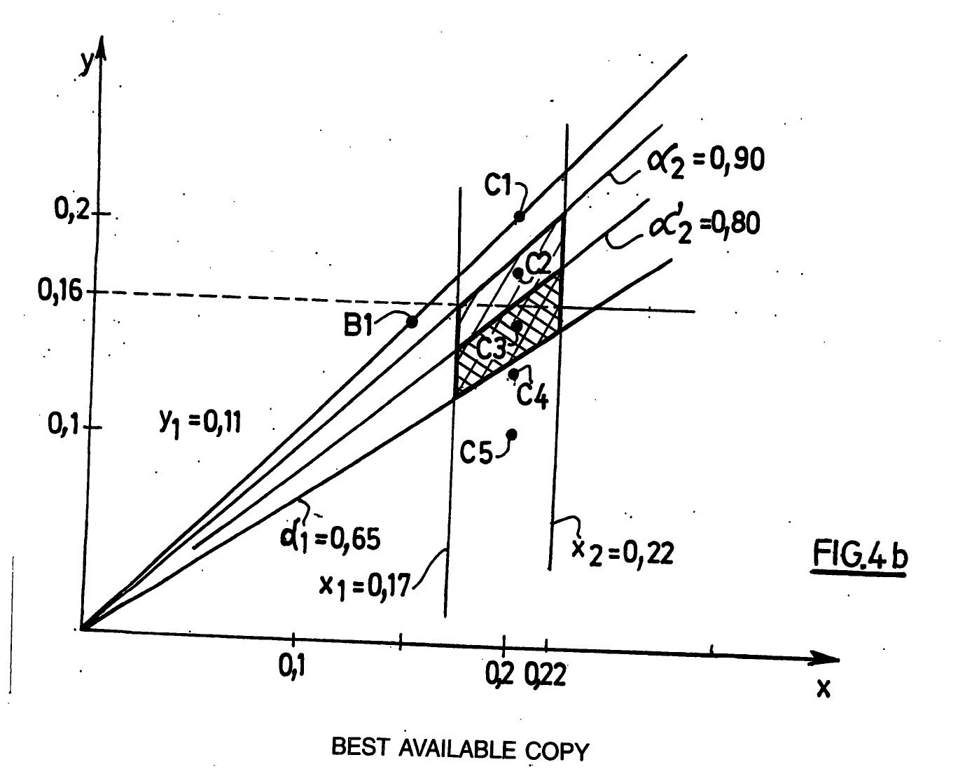

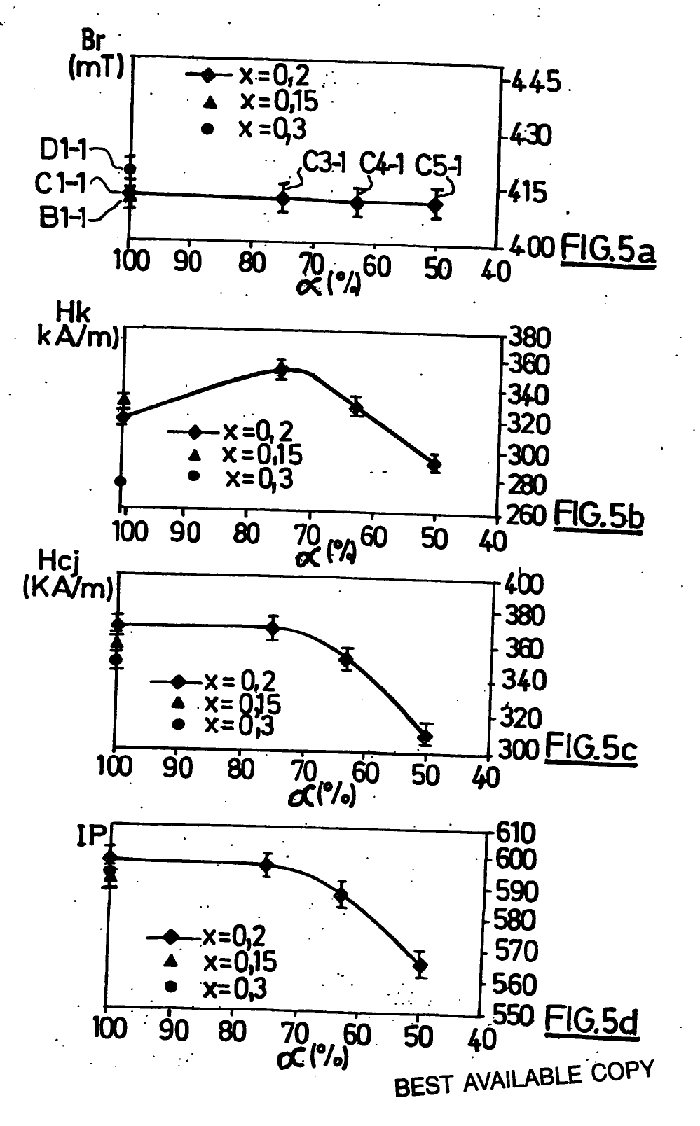

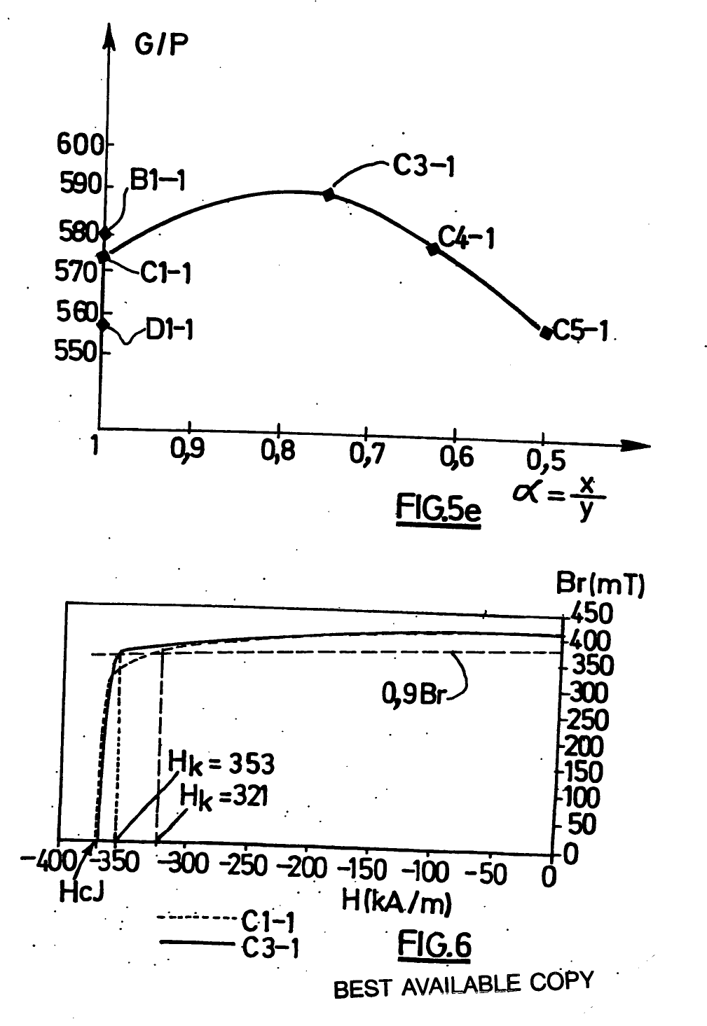

This sub-domain of the invention is shown in FIGS. 3 and 4a.

Another, more preferred, sub-domain corresponds to the following condition: 0.17<x<0.22.

This domain is shown in FIG. 4b.

The tests showed that the best results are obtained in tests conducted with x greater than 0.15 and typically greater than 0.17.

Also, if excellent results were obtained with x=0.4, these results were not better than those obtained with x=0.3. In addition, having regard to the fact that magnets with x=0.4 are significantly more costly than those in which x=0.3 (for one same coefficient α) it is preferred that x does not exceed 0.32.

Similarly, since few differences in properties were noted between tests with x=0.3 and with x=0.2, it was found to be advantageous to have magnets in which x is no more than 0.22 so as to obtain particularly economical ferrite magnets.

Other sub-domains are limited by the coefficient α=y/x as illustrated in FIGS. 3 to 4b.

The tests showed the advantage of magnets having the relationship: 0.60<α=y/x<0.90, and preferably 0.65<α=y/x<0.90, the latter domain being illustrated in FIG. 4a for example.

One sub-domain of interest is also the one defined by the relationship 0.60<α=y/x<0.80, and preferably the one defined by the relationship 0.65<α=y/x<0.80 the latter being illustrated in FIG. 4b.

Having regard to the particular interest of test C3, which reconciles a very low La content with high performance, a narrow domain in which α=y/x ranges from 0.67 to 0.77 is particularly advantageous. The domain that technically and economically is of most interest is the one defined by 0.17<x0.22 and 0.67≦α≦0.77.

With the invention it is advantageously possible to have ferrites with low T element content in which the coefficient y is no more than 0.16, even no more than 0.15, while maintaining a very high level of overall performance.

In addition it is important to note that the ferrites of the invention can be obtained under sintering conditions, particularly at a relatively low sintering temperature, in particular of 1220° C. or less, and typically less than 1200° C. which is advantageous from an economical viewpoint.

All the ferrite tests of the invention were conducted with M=Sr, R═La and T=Co. However, the invention is not limited to this specific ferrite.

For example, element M may be a mixture of Sr and Ba, the atomic percentage of Sr ranging from 10% to 90% and that of Ba from 90% to 10%, and in which R═La and T=Co.

In another embodiment of the invention, the atomic concentrations of the elements designated by T meet the condition [Co]/([Co)+[Zn]+[Mn]+[Ni]>30%, preferably >50% and further preferably >70%. In this embodiment, it is also possible to choose M=Sr and R═La.

A further subject of the invention is the use of a ferrite magnet according to the invention in an application requiring:

either a magnet simultaneously having a magnetic index of performance IP greater than 590 mT and strong squareness of the demagnetising curve, typically with a ratio h_{K}=Hk/HcJ (%) of at least 95%,

or a magnet with global performance index GIP of at least 580, and preferably at least 585.

A further subject of the invention is a process for manufacturing a magnet of the invention in which:

a) a mixture of the precursors of elements M, R, T and Fe is formed corresponding to the stoichiometry of formula M₁₋ₓRₓFe_{12-y}T_{y}O₁₉ with the conditions: 0.15<x<0.42 and 0.50<α=y/x<0.90,

b) said mixture is calcined under conditions of temperature and time typically in the region of 1250° C. and for 2 hours so as to obtain a clinker,

c) said clinker is pulverized with optional incorporation of additives, so as to obtain a fine particle powder with a mean particle size of less than 1 μm,

d) said particles are subjected to an orienting magnetic field typically of 1T and sintered at a temperature typically ranging from 1150 to 1250° C., said temperature being chosen so that it is possible to obtain a magnet having:

either a maximum global performance index GIP, typically of at least 580, and preferably of at least 585,

or, simultaneously, an index of performance IP=Br+0.5.HcJ typically of at least 590 mT, and demagnetising curve squareness h_{K}=HK/HcJ (%), Hk corresponding to the field H when B=0.9 Br, typically of at least 95%.

It is also possible to apply to the invention the teaching provided by the manufacturing processes described in French applications n° 99 10295 and 99 15093 on behalf of the applicant.

The following examples are given by way of illustration and are not of a restrictive nature.

### EXAMPLES

For laboratory testing the previously described process was used:

Step a:

Stoichiometric wet mixtures corresponding to the ferrite magnets of composition Sr₁₋ₓLaₓFe_{12-y}CO_{y}O₁₉ were prepared, with the following values for x and y:

| Test reference | X | Y | X/Y = a (%) |
|---|---|---|---|
| A0 | 0 | 0 | — |
| A1 | 0.10 | 0.10 | 100 |
| A2 | 0.10 | 0.075 | 75 |
| A3 | 0.10 | 0.05 | 50 |
| B1 | 0.15 | 0.15 | 100 |
| B2 | 0.15 | 0.132 | 88 |
| B3 | 0.15 | 0.112 | 75 |
| B4 | 0.15 | 0.1 | 63 |
| B5 | 0.15 | 0.75 | 50 |
| C1 | 0.2 | 0.2 | 100 |
| C2 | 0.2 | 0.176 | 88 |
| C3 | 0.2 | 0.15 | 75 |
| C4 | 0.2 | 0.126 | 63 |
| C5 | 0.2 | 0.1 | 50 |
| D1 | 0.30 | 0.30 | 100 |
| D2 | 0.30 | 0.264 | 88 |
| D3 | 0.30 | 0.225 | 75 |
| D4 | 0.30 | 0.189 | 63 |
| D5 | 0.30 | 0.15 | 50 |
| E1 | 0.40 | 0.40 | 100 |
| E2 | 0.40 | 0.352 | 88 |
| E3 | 0.40 | 0.30 | 75 |
| E4 | 0.40 | 0.252 | 63 |
| E5 | 0.40 | 0.2 | 50 |

As raw materials, the following powders were used:

for element Sr: SrCO₃

for element La: La₂O₃ in powder form with a specific surface area of 1.07 m²/g (BET method) and mean particle diameter of 0.93 μm, the diameter being measured using Fisher's method,

for element Fe: Fe₂O₃ in powder form with a specific surface area of 3.65 m²/g and a mean particle diameter of 0.96 μm,

for element Co: Co₃O₄ in powder form with a specific surface area of 0.96 m²/g and a mean particle diameter of 2.1 μm.

The powders were mixed in a mixer in aqueous phase, the mixture was filtered and dried. The powder obtained was pelleted to a density of 2.5 kg/dm³ using water as binding agent (humidity content: 14% by weight), the pellets being dried before calcining.

Step b): the powder mixture was calcined at 1250° C. for 2 hours.

A clinker having the following properties was obtained:

| | density = d | HcJ (kA/m) = Coercive | Br/d (mT · cm³/g) |
|---|---|---|---|
| Reference | in g/cm³ | field | Rem. induction* |
| A0 | 2.91 | 301 | 44.7 |
| A1 | 2.87 | 299 | 45.1 |
| A2 | 2.90 | 311 | 44.8 |
| A3 | 3.01 | 306 | 45.0 |
| B1 | 2.85 | 333 | 44.6 |
| B2 | 3.01 | 315 | 44.5 |
| B3 | 3.04 | 313 | 44.1 |
| B4 | 3.03 | 320 | 43.9 |
| B5 | 3.1 | 315 | 43.5 |
| C1 | 2.74 | 355 | 46.7 |
| C2 | 2.97 | 347 | 44.1 |
| C3 | 2.74 | 354 | 45.6 |
| C4 | 2.91 | 364 | 43.6 |
| C5 | 2.87 | 359 | 46.3 |
| D1 | 2.97 | 371 | 43.8 |
| D2 | 3.01 | 374 | 44.5 |
| D3 | 2.85 | 405 | 45.3 |
| D4 | 2.9 | 390 | 44.8 |
| D5 | 2.91 | 361 | 45.7 |
| E1 | 2.81 | 392 | 45.2 |
| E2 | 2.94 | 421 | 44.7 |
| E3 | 2.75 | 436 | 44.7 |
| E4 | 2.80 | 443 | 43.9 |
| E5 | 2.81 | 457 | 43.8 |

*remanent induction on calcined density - it is proportional to the reaction yield.

Step c): in a wet medium the clinker obtained was pulverized with the addition—by weight—of:

0.52% SiO₂ (in the form of an aqueous solution at 20% concentration)

0.86% CaCO₃

0.95% SrCO₃

Particle size of the paste obtained: the particles have a mean diameter of between 0.58 μm and 0.62 μm and a BET specific surface area of between 10.3 and 11.2 m²/g so that measurements of final magnet properties may be comparable.

Step d):

After grinding, the particles were subjected to an orienting magnetic field, typically of 1T, and sintered at temperatures of: 1180° C., 1205° C., 1220° C. or 1240° C.

Results in relation to sintering temperature T° C. and sintering time of 25 min. were as follows:

| | | | HcJ | Hk | IP = | h_{K} = Hk/ | GIP = |
|---|---|---|---|---|---|---|---|
| Test ref. | T° C. | Br (mT) | (kA/m) | (kA/m) | Br + HcJ/2 | HcJ (%) | Br + Hk/2 |
| A0-1 | 1180° C. | 410 | 272 | 267 | 546 | 98 | 543.5 |
| A1-1 | ″ | 411 | 328 | 312 | 575 | 95.1 | 567 |
| A2-2 | ″ | 418 | 325 | 314 | 581 | 96.6 | 575 |
| A3-1 | ″ | 414 | 311 | 296 | 570 | 95.2 | 569 |
| B1-1 | ″ | 413 | 360 | 332 | 593 | 92 | 579 |
| B2-1 | ″ | 420 | 347 | 331 | 594 | 95.4 | 586 |
| B3-1 | ″ | 417 | 348 | 348 | 591 | 95.1 | 583 |
| B4-1 | ″ | 418 | 335 | 319 | 586 | 95.2 | 578 |
| B5-1 | ″ | 419 | 321 | 309 | 580 | 96.3 | 574 |
| C1-1 | ″ | 413 | 371 | 321 | 599 | 86 | 573.5 |
| C2-1 | ″ | 420 | 376 | 350 | 608 | 93.1 | 595 |
| C3-1 | ″ | 412 | 369 | 353 | 597 | 96 | 588.5 |
| C4-1 | ″ | 411 | 353 | 330 | 588 | 93 | 576 |
| C5-1 | ″ | 411 | 310 | 293 | 566 | 94 | 557.5 |
| D1-1 | ″ | 419 | 350 | 278 | 594 | 79 | 558 |
| D2-1 | ″ | 420 | 360 | 296 | 600 | 82.2 | 568 |
| D3-1 | ″ | 423 | 368 | 336 | 607 | 91.3 | 591 |
| D4-1 | ″ | 413 | 356 | 339 | 591 | 95.2 | 583 |
| D5-1 | ″ | 418 | 302 | 278 | 569 | 92.1 | 557 |
| E1-1 | ″ | 410 | 277 | 238 | 549 | 86 | 52.9 |
| E2-1 | ″ | 425 | 333 | 268 | 592 | 80.5 | 559 |
| E3-1 | ″ | 417 | 362 | 292 | 598 | 81 | 563 |
| E4-1 | ″ | 418 | 350 | 322 | 593 | 92 | 579 |
| E5-1 | ″ | 415 | 291 | 263 | 561 | 90 | 546.5 |
| A0-2 | 1205° C. | 410 | 265 | 257 | 542 | 94 | 538.5 |
| A1-2 | ″ | 425 | 316 | 307 | 583 | 97.2 | 579 |
| A2-2 | ″ | 421 | 314 | 307 | 578 | 97.8 | 575 |
| A3-2 | ″ | 417 | 302 | 293 | 568 | 97.0 | 564 |
| B1-2 | ″ | 417 | 350 | 330 | 592 | 94 | 582 |
| B2-2 | ″ | 413 | 336 | 321 | 581 | 95.5 | 574 |
| B3-2 | ″ | 417 | 335 | 325 | 585 | 97 | 580 |
| B4-2 | ″ | 421 | 325 | 316 | 584 | 97.2 | 579 |
| B5-2 | ″ | 420 | 306 | 298 | 573 | 97.4 | 569 |
| C1-2 | ″ | 421 | 358 | 320 | 600 | 89 | 581 |
| C2-2 | ″ | 419 | 365 | 344 | 602 | 94.2 | 591 |
| C3-2 | ″ | 419 | 356 | 344 | 597 | 97 | 591 |
| C4-2 | ″ | 416 | 349 | 340 | 592 | 97 | 586 |
| C5-2 | ″ | 417 | 328 | 319 | 581 | 97 | 576.5 |
| D1-2 | ″ | 419 | 350 | 278 | 594 | 79 | 558 |
| D2-2 | ″ | 427 | 355 | 337 | 605 | 94.9 | 596 |
| D3-2 | ″ | 427 | 355 | 337 | 605 | 94.9 | 596 |
| D4-2 | ″ | 425 | 342 | 333 | 596 | 97.4 | 592 |
| D5-2 | ″ | 427 | 316 | 308 | 585 | 97.5 | 581 |
| E1-2 | ″ | 426 | 252 | 235 | 552 | 93 | 543.5 |
| E2-2 | ″ | 427 | 336 | 272 | 595 | 81 | 563 |
| E3-2 | ″ | 426 | 352 | 293 | 602 | 83 | 572.5 |
| E4-2 | ″ | 420 | 345 | 323 | 593 | 94 | 581 |
| E5-2 | ″ | 425 | 311 | 298 | 581 | 96 | 574 |
| A1-3 | 1220° C. | 423 | 310 | 297 | 578 | 95.8 | 572 |
| A2-3 | ″ | 421 | 307 | 295 | 575 | 96.1 | 569 |
| A3-3 | ″ | 419 | 296 | 287 | 567 | 97.0 | 563 |
| B1-3 | ″ | 420 | 342 | 332 | 600 | 97 | 586 |
| B2-3 | ″ | 424 | 332 | 320 | 590 | 96.4 | 578 |
| B3-3 | ″ | 420 | 326 | 316 | 583 | 96.9 | 578 |
| B4-3 | ″ | 423 | 317 | 307 | 582 | 96.8 | 577 |
| B5-3 | ″ | 424 | 303 | 295 | 576 | 97.4 | 572 |
| C1-3 | ″ | 425 | 353 | 321 | 602 | 91 | 585.5 |
| C2-3 | ″ | 421 | 358 | 336 | 600 | 93.9 | 589 |
| C3-3 | ″ | 424 | 351 | 339 | 600 | 97 | 593.5 |
| C4-3 | ″ | 424 | 342 | 332 | 600 | 97 | 586 |
| C5-3 | ″ | 419 | 324 | 315 | 581 | 97 | 576.5 |
| D1-3 | ″ | 429 | 320 | 263 | 589 | 82.2 | 561 |
| D2-3 | ″ | 429 | 348 | 308 | 603 | 88.5 | 583 |
| D3-3 | ″ | 427 | 353 | 335 | 604 | 94.9 | 595 |
| D4-3 | ″ | 426 | 337 | 328 | 595 | 97.3 | 590 |
| D5-3 | ″ | 427 | 311 | 300 | 585 | 96.5 | 579 |
| E2-3 | ″ | 434 | 332 | 271 | 600 | 81.6 | 570 |
| E3-3 | 1240° C. | 431 | 339 | 297 | 601 | 87.5 | 580 |
| E4-3 | ″ | 429 | 335 | 322 | 597 | 96.1 | 590 |
| E5-3 | ″ | 428 | 308 | 297 | 582 | 96.4 | 577 |

Conclusions: if the tests with reduced content of element T are compared, all other things being equal, namely same value for x and sintering temperature in particular (see for example couples C1-1 and C3-1, C1-2 and C3-2, C1-3 and C3-3), it is obvious that with the invention it is possible simultaneously to obtain:

less costly ferrites, since the invention typically enables 30% replacement of cobalt by iron, and the use of a relatively low magnet sintering temperature,

ferrites that are globally better performing.

In particular, the very high performance level can be noted, with GIP>590, obtained in tests C2-2, C3-3 and D2-2, the most economical ferrite being the one corresponding to test C3-3.

1. Magnet of ferrite type containing a magnetoplumbite phase of formula M₁₋ₓRₓFe_{12-y}T_{y}O₁₉ in which:
M designates at least one element chosen from the group made up of: Sr, Ba, Ca and Pb,
R designates at least one element chosen from among the rare earths and Bi,
T designates at least one element chosen from among Co, Mn, Ni, Zn
0.15<x<0.42
0.50<α=y/x<0.90
so as to obtain a ferrite magnet simultaneously having a reduced content of element T and a global index of performance GIP=Br+0.5.Hk of at least 580, preferably of at least 585, Br being the remanent induction expressed in mT, Hk corresponding to the field H expressed in kA/m, when B=0.9Br.

2. Magnet as in claim 1, in which the x coefficient ranges from 0.15 to 0.32.

3. Magnet as in claim 2, in which the x coefficient ranges from 0.17 to 0.22.

4. Magnet as in claim 1, in which there is a relationship: 0.60<α=y/x<0.90, and preferably 0.65<_=y/x<0.90.

5. Magnet as in claim 4, in which there is a relationship: 0.60<α=y/x<0.80 and preferably 0.65<α=y/x<0.80.

6. Magnet as in claim 5, in which α=y/x ranges from 0.67 to 0.77.

7. Magnet as in claim 1, in which the atomic concentrations of the elements designated by T meet the condition [Co]/([Co]+[Zn]+[Mn]+[Ni])>30%.

8. Magnet as in claim 7, in which the atomic concentrations of the elements designated by T meet the condition: [Co]/([Co]+[Zn]+[Mn]+[Ni])>50%.

9. Magnet as in claim 7, in which the atomic concentrations of the elements designated by T meet the condition: [Co]/([Co]+[Zn]+[Mn]+[Ni])>70%.

10. Magnet as in claim 7, in which M=Sr and R═La.

11. Magnet as in claim 1, in which M is equal to a mixture of Sr and Ba, the atomic percentage of Sr ranging from 10% to 90% and that of Ba from 90% to 10%, and in which R═La and T=Co.

12. Magnet as in claim 1, in which M=Sr and R═La.

13. Magnet as in claim 12, in which T=Co.

14. (canceled)

15. Process for manufacturing a magnet of ferrite type containing a magnetoplumbite phase having the formula M₁₋ₓRₓFe_{12-y}T_{y}O₁₉ in which:
M designates at least one element chosen from the group made up of: Sr, Ba, Ca and Pb,
R designates at least an element chosen from among the rare earths and Bi,
T designates at least one element chosen from among Co, Mn, Ni, Zn,
said process comprising the following steps:
a) a mixture of the precursors of elements M, R, T and Fe is formed corresponding to the stoichiometry of formula M₁₋ₓRₓFe_{12-y}T_{y}O₁₉ with the conditions: 0.15<x<0.42 and 0.50<α=y/x<0.90,
b) said mixture is calcined under conditions of temperature and time typically in the region of 1250° C. for 2 hours so as to obtain a clinker,
c) said clinker is pulverized with optional incorporation of additives, so as to obtain a fine particle powder with a mean particle size of less than 1 μm,
d) said particles are subjected to an orienting magnetic field typically of 1T and sintered at a temperature typically ranging from 1150 to 1250° C., said temperature being chosen so that it is possible to obtain a magnet having:
either a maximum global performance index GIP, typically of at least 580, and preferably of at least 585,
or, simultaneously, an index of performance IP=Br+0.5.HcJ typically of at least 590 mT, and a squareness index of the demagnetising curve h_{K}=Hk/HcJ (%), Hk corresponding to the field H when B =0.9.Br, typically of at least 95%.

16. Process as in claim 15, characterized in that the mixture of precursors meets the condition 0.15<x<0.32.

17. Process as in claim 16, characterized in that the mixture of precursors meets the condition 0.17<x<0.22.

18. Process as in claim 15, characterized in that the mixture of precursors meets the condition 0.60<α=y/x<0.90.

19. Process as in claim 15, characterized in that the mixture meets the condition: 0.65<α=y/x<0.90.

20. Process as in claim 15, characterized in that the mixture meets the condition 0.60<α=y/x<0.80.

21. Process as in claim 15, characterized in that the mixture meets the condition 0.65<α=y/x<0.80.

22. Process as in claim 15, characterized in that the mixture meets the condition 0.67<α=y/x<0.77.

23. Process as in claim 15, in which the sintering temperature at step d) does not exceed 1220° C.

24. Process as in claim 23, in which the sintering temperature at step d) is less than 1200° C.
